(19) United States
(12) Patent Application Publication
(10) Pub. No.: US 2024/0393489 A1
(43) Pub. Date: Nov. 28, 2024

(54) METHOD AND SYSTEM FOR SEISMIC ANOMALY DETECTION

(71) Applicant: ExxonMobil Technology and Engineering Company, Spring, TX (US)

(72) Inventors: Victoria Som De Cerff-Edmonds, Jersey City, NJ (US); Huseyin Denli, Basking Ridge, NJ (US); Cody MacDonald, Houston, TX (US); Jaquelyn Daves, Houston, TX (US)

(73) Assignee: ExxonMobil Technology and Engineering Company, Spring, TX (US)

(21) Appl. No.: 18/696,204

(22) PCT Filed: Sep. 16, 2022
(86) PCT No.: PCT/US22/43781

§ 371 Date: Mar. 27, 2024

Related U.S. Application Data
(60) Provisional application No. 63/261,792, filed on Sep. 29, 2021.

(51) Int. Cl. G01V 1/34; G01V 1/30; G06N 20/00

(52) U.S. Cl. CPC G01V 1/345; G01V 1/301; G01V 1/307; G06N 20/00

(57) ABSTRACT

A method and system for seismic anomaly detection is disclosed. Hydrocarbon prospecting relies on accurate modeling of subsurface geologic structures and detecting fluid presence in the geologic structures. For example, a seismic survey is gathered and processed to create a mapping of the subsurface region. The processed data is then examined, such as by comparing pre- or partially-stacked seismic images, in order to identify subsurface structures that may contain hydrocarbons. Instead of relying on engineered image attributes, which may be unreliable and biased, to identify anomalous features, an unsupervised machine learning framework is used to learn the relationships among partially-stack images or among pre-stack images to detect the anomalous features, and in turn hydrocarbon presence.

### REFERENCE TO RELATED APPLICATION

The present application claims priority to U.S. Provisional Application No. 63/261,792 filed on Sep. 29, 2021, the entirety of which is incorporated by reference herein.

### FIELD OF THE INVENTION

The present application relates generally to the field of hydrocarbon exploration, development and production. Specifically, the disclosure relates to a methodology and framework for unsupervised machine-learning for detecting amplitude variations with offset (AVO) anomalies from seismic images by learning relationships across partially-stack or pre-stack images.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

An important step of hydrocarbon prospecting is to accurately model subsurface geologic structures and detect fluid presence in those structures. For example, a seismic survey may be gathered and processed to create a mapping (e.g., subsurface images such as 2-D or 3-D partially-stacked migration images presented on a display) of the subsurface region. The processed data may then be examined (e.g., analysis of seismic images) with a goal of identifying subsurface structures that may contain hydrocarbons. Some of those geologic structures, particularly hydrocarbon bearing reservoirs, may be directly identified by comparing pre- or partially-stacked seismic images (e.g., near stack image, mid stack image and far stack image).

One quantitative way of comparing the stack images is based on analysis of amplitude changes with offset or angle (amplitude versus offset (AVO) or amplitude versus angle (AVA)). Examples of AVO and AVA are disclosed in US Patent Application Publication No. 2003/0046006 A1, US Patent Application Publication No. 2014/0278115 A1, US Patent Application Publication No. 2020A0132873 A1, and U.S. Pat. No. 8,706,420, each of which is incorporated by reference herein in their entirety.

Typically, the relationship among the pre- or partially-stacked images (e.g., transition from near-stack to far-stack images) are considered to be multimodal (e.g., exhibiting multiple maxima) due to the offset-dependent responses of the geological structures and fluids (e.g., amplitude-versus-offset responses of hydrocarbon bearing sand, water-bearing sand, shale facies or salt facies can be different). It may be easier to detect such AVO changes in clastic reservoirs than ones in carbonate reservoirs. At reflection regimes, the relations among the stack images (AVO) may be explained by the Zoeppritz equation that describes the partitioning of seismic wave energy at an interface, a boundary between two different rock layers. Typically, the Zoeppritz equation is simplified for the pre-critical narrow-angle seismic reflection regimes and range of subsurface rock properties (e.g., Shuey approximation), and may be reduced to:

$$R ( θ ) = A + B {sin}^{2} ( θ ) \qquad ( 1 )$$

where R is the reflectivity, θ is the incident angle, A is the reflectivity coefficient at zero incident angle (θ=0), and B is the AVO gradient. The stack images may be used to determine A and B coefficients. These coefficients may be estimated over each pixel over the seismic image, over a surface (boundaries along the formations) or over a geobody (e.g., performing mean and standard deviations of A and B values over a geobody region). AVO is not the only indicator of fluid presence and may not be the most reliable indicator because the fluid effects may be obscured due to the inaccuracies in seismic processing, the seismic resolution, and presence of noise or the seismic interference of thin beds. Other hydrocarbon indicators may be useful for derisking hydrocarbon presence include: amplitude terminations; anomaly consistency; lateral amplitude contrast; fit to structure; anomaly strength; and fluid contact reflection. Thus, distributions of A and B values may be interpreted to distinguish the AVO anomalies from the background as an AVO response of hydrocarbon presence is expected to be anomalous. Further, this AVO analysis may be combined with the other indicators to increase the confidence around fluid presence.

### SUMMARY OF THE INVENTION

In one or some embodiments, a computer-implemented method for detecting anomalous features from seismic images is disclosed. The method includes: accessing input seismic stack images; performing unsupervised machine learning, using at least a part of the seismic stack images, to generate a model that is configured to reconstruct the seismic stack images; using the model in order to generate reconstructed seismic stack images; assessing reconstructive errors based on the reconstructed seismic stack images with the input seismic stack images; detecting the anomalous features based on the assessment of the reconstructive errors; and using the detected anomalous features for hydrocarbon management.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 illustrates a block diagram of an autoencoder.

FIG. 2 illustrates a block diagram of an autoencoder architecture.

FIG. 3 illustrates a U-net (including autoencoder with skip connections) architecture.

FIG. 4 illustrates one example of anomaly detection using training losses.

FIG. 5 illustrates cycleGAN components for training the model.

FIG. 6 illustrates a workflow for anomaly detection, characterization, and user feedback for retraining.

FIG. 7 illustrates an image of anomalous features highlighted by the reconstruction errors of far-stack images.

FIG. 8 is an illustration of construction of anomalous geobodies.

FIG. 9 is an illustration of AVO characterization in a pixelated image space.

FIG. 10 is an illustration of the characterization of anomalous geobodies in AVO space depicted with A and B axes.

FIG. 11 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth hemin. Further, variations in the processes described, including the addition, deletion, or rearranging and order of logical operations, may be made without departing from the spirit or scope of the claims as set forth hemin.

It is to be understood that the present disclosure is not limited to particular devices or methods, which may, of course, vary. It is also to be understood that the terminology used herein is for the purpose of describing particular embodiments only, and is not intended to be limiting. As used hemin, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “hydrocarbon management” or “managing hydrocarbons” includes any one, any combination, or all of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, the prior art attempts to detect AVO anomalies in order to identify hydrocarbon presence. However, there are several failings in the current methodologies to detect anomalies. First, the Zoeppritz equation is crude approximation to the relationships of the field pre- and partially stack images because of the complex interactions of seismic waves, noise and inaccuracies in processing and migration imaging. Such equations may be useful for reasoning about how seismic waves interact with the subsurface but may be insufficient to process the data. Second, flat reflections may be caused by a change in stratigraphy and may be misinterpreted as a fluid contact. Third, rocks with low impedance could be mistaken for hydrocarbons, such as coal beds, low density shale, ash, mud volcano, etc. Fourth, polarity of the images could be incorrect, causing a bright amplitude in a high impedance zone. Fifth, AVO responses may be obscured by superposition of seismic reflections and tuning effects. Sixth, the signal may be contaminated with systematic or acquisition noise.

Various workflows to identify anomalies are contemplated. One example workflow may heavily depend on engineered image attributes to identify anomalies, which may typically lead to an unreliable and biased pick of the anomalous features. Other example workflows may rely on supervised machine learning, which do not rely on the feature engineering but do require an abundant amount of labelled examples to train the network. The requirement of a large amount of labelled training data is a challenge for many important interpretation tasks, particularly for direct hydrocarbon indicators (DHIs), for a variety of reasons. One reason is that generating labelled data for fluid detection is a labor-intensive process. Another reason is that DHIs are often difficult to pick, particularly subtle DHIs. This may limit the total number of training data that may be generated, even with the unlimited resources.

Thus, in one or some embodiments, an unsupervised machine learning framework is used to generate a model, which in turn may be used to identify anomalies of interest (e.g., anomalous feature presence) in a subsurface, and in turn hydrocarbon presence. In one or some embodiments, the model may be trained to learn the relationships among sets of images (e.g., partially-stack images or among pre-stack images). In particular, the unsupervised learning methodology may learn the relationships between pairs of images for detecting anomalous features from seismic images over a geological background (e.g., by randomly sampling patches from the input seismic stack images to train the model, thereby using at least a part of the seismic stack images to generate the model). In turn, the trained model may be used to reconstruct images, with a comparison of the reconstructed images and the original images being used to identify anomalies in the subsurface. This is in contrast to current workflows for identifying anomalies.

Various anomalies may be present in the subsurface; however, not all anomalies in the subsurface may be of interest. As such, in one or some embodiments, only a subset of reconstruction errors (caused by the model inaccurately reconstructing the image) corresponding to anomalies indicative of hydrocarbon presence, are of interest. To focus on the anomalies of interest, the unsupervised training of the model is configured to train the model to reconstruct certain features competently (such as the background, discussed below) and not to reconstruct other features competently (such as the anomalies of interest).

Various methods are contemplated to tailor the training of the model to enable the model to reconstruct certain features while being unable to reconstruct others. As one example, the type of data may be selected to train the model so that the model may competently reconstruct a part of the subsurface (e.g., the background for a specific region, such as a specific zone). In particular, various data preparation techniques, such as selecting image patches from the specific zone of interest and/or masking sections of images outside of the specific zone of interest. In this way, the training may be tailored to a specific zone so that the background associated with the specific zone may be competently reconstructed, whereas other features, such as anomalies that may be present in the specific zone separate from the background and indicative of hydrocarbon presence, may not be competently reconstructed (e.g., the unsupervised machine learning is constrained to a geologic context where anomalous features are defined, such as any one, any combination or all of a geologic age, zone, environment of deposition (EoD), or facies). Thus, in one or some embodiments, the inputs to the model may include geophysical inversion results, depth, geologic zone, geologic age, environment of deposition, and the input seismic stack images. As another example, training may be tailored so that certain types of features are competently reconstructed whereas other types of features are not.

Further, various types of anomalies may be of interest. Merely by way of example, two types of anomalies comprise amplitude anomalies (e.g., anomalies regarding amplitude versus offset or angle effect associated with the reservoir relative to the background) and structural anomalies (e.g., a geometrical anomaly). In one embodiment, the anomalies of interest may comprise amplitude anomalies whereas structural anomalies are not of interest. As such, the model is trained using data that enables the trained model to reconstruct the structure competently and does not enable the trained model to reconstruct amplitude accurately or competently. For example, the methodology may augment the seismic data (e.g., generate additional training data by rotating the seismic data, such as rotating images based on ranges of dipping angles) in a way that the trained model will reconstruct images that are invariant to the structural changes (e.g., the trained model is structurally invariant). For example, one or more pre-stack input images may be used to construct other pre-stack images, with some or all of the pre-stack images being inputs to the model and some or all pre-stack images being outputs of the model. Thus, when the trained model reconstructs an image, amplitude anomalies may be present (and geometrical/structural components are competently recreated in the reconstructed image). Conversely, the anomalies of interest may comprise structural anomalies as opposed to amplitude anomalies. As such, the model is trained using data that enables the trained model to reconstruct the amplitude competently and does not enable the trained model to reconstruct structure competently. Still alternatively, the anomalies of interest may include both amplitude and structural anomalies.

After training the model, the model may be used in order to identify anomalous features. In one or some embodiments, the model may be used to reconstruct an image, with the reconstructed image being compared in one or more ways with the original image in order to identify the anomaly(ies). Various ways are contemplated to ways to identify anomalous features including (1) reconstruction loss at the pixel level (e.g., the model generates a reconstructed pixel image, which is compared with the original pixel image in order to identify anomalies based on differences in pixel values greater than a predetermined threshold; (2) reconstruction at the latent space; and (3) generative adversarial network (GAN) rating of the anomalous feature (e.g., with the GAN rating indicative of whether the patch has an anomalous feature or not). One, some, or each of the ways may generate a corresponding score or indication of anomaly. In one or some embodiments, the scores of only one of the ways may be analyzed. Alternatively, scores from more than one way (such as scores from each of the three ways listed above) may be analyzed (such as combined) to determine whether that patch includes an anomaly.

Separate from, or in addition to, identifying whether a part of the image (such as an image patch) includes an anomaly, the location of the anomaly may likewise be determined. For example, pixel level reconstruction may be used to identify an anomaly (such as by comparison with the original pixel image). In addition, the methodology may identify where within the original pixel image, the anomaly occurs. In this regard, the methodology may identify a location of the anomaly.

Further, in one or some embodiments, the methodology may be used alone to identify the anomalies of interest. Alternatively, the methodology, which includes unsupervised training, may be paired with another methodology, such as supervised training. For example, in one embodiment, two separate models, one generated via supervised training and another generated via unsupervised training, may be used to determine anomalous features (e.g., the anomalous features may be detected based on assessment of reconstruction errors from images generated from a first model (generated via unsupervised learning) and from a second model (generated via supervised learning)).

As discussed above, various types of seismic data including any one, any combination, or all of the following may be analyzed in order to determine anomalies: pre-stack images; partial-stack images; geophysical property maps (e.g., compressional wave speed, shear wave speed, anisotropy, attenuation quality factors, density, pore pressure, etc.); or depth and travel time images. In one particular embodiment, anomalous features may be identified from seismic images by analyzing the changes among pre- or partially-stack images. For the data, multiple stacks (e.g., near and far stacks) may be used. Further, the analysis may be performed in one or more ways including: (1) learning from near to far seismic stacks (reconstruction from near to far); or (2) near to far of different stacks.

Without loss of generality, one may assume that there are two seismic images (e.g., near-stack and far-stack images) A and B, and the changes between two images may depend on some aspect of the subsurface, such as on the fluid type (e.g., hydrocarbon or water). For example, AVO may measure the amplitude changes between near-offset and far-offset images. In this case, A may represent the distributed values of near-offset images and B may represent the distributed values of far-offset images. In another case, A and B may be derived from equation (1) R(θ)=A+B sin²(θ) for near and far-offset angles θ_{Near} (e.g. 5°) and θ_{Far} (e.g. 15°) and near- and far-offset image R(θ_{Near}) and R(θ_{Far}). In another case, A and B axes may represent first two principal axes derived from the PCA analysis of the distribution of near and far offset image values R(θ_{Near}) and R(θ_{Far}).

A and B may also be collections of seismic images or volumes, such as a set of datasets X₁, . . . , X_{N} (e.g., pre-stack images). For instance, pre-stack images may be split into two groups,

$$A ∈ {X}_{1} , … {X}_{N / 2} and B ∈ {X}_{\frac{n}{2} + 1} , … {X}_{N} or A ∈ {X}_{1} , … {X}_{N - 1} and B ∈ {X}_{N}$$

or a combination of these groupings.

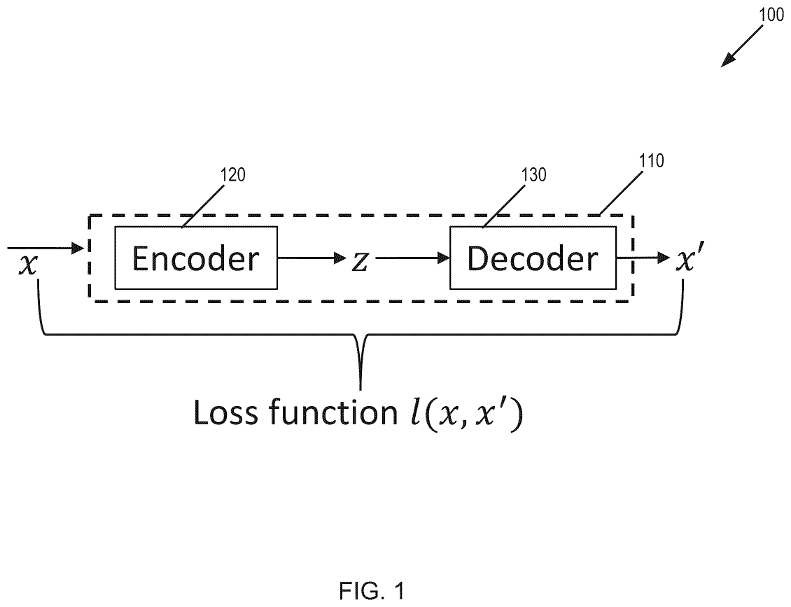

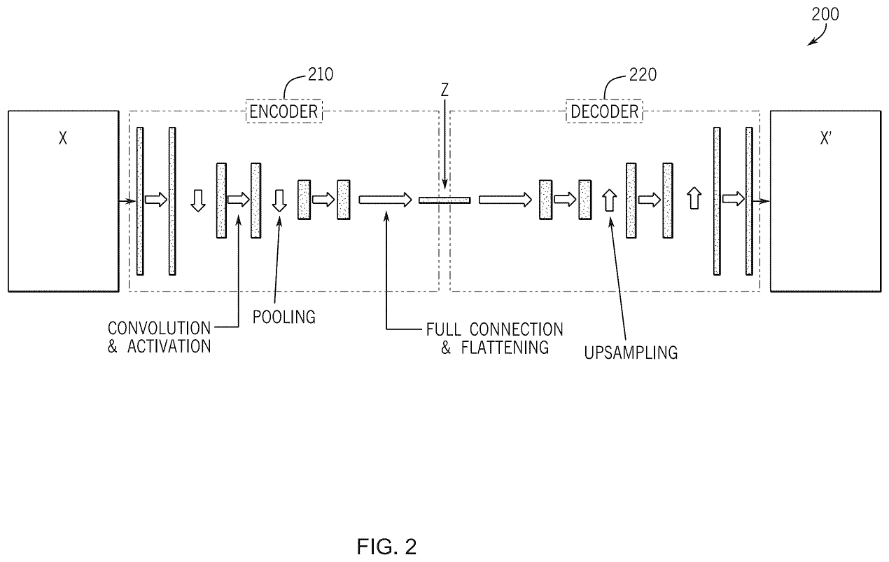

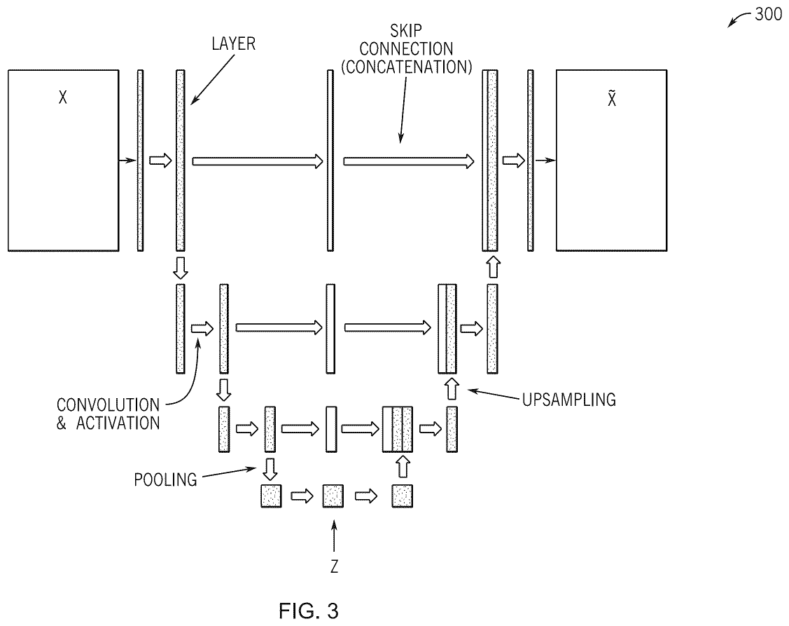

For paired A and B images, modern machine learning models such as autoencoders (illustrated in FIGS. 1 and 2, discussed below), autoencoders with skip layers (e.g., U-net as illustrated in FIG. 3), generative adversarial networks, normalizing flow networks. Siamese networks, self-supervised network (e.g., contrastive learning) may be used to encode input images into a latent space (e.g., hidden space or bottleneck layer) or an embedding space and then decode to a corresponding output image.

In particular, the methodology may include an unsupervised learning approach, as discussed above. Various methods of unsupervised learning are contemplated. Example unsupervised learning methods for extracting features from images may be based on clustering methods (k-means), generative-adversarial networks (GANs), transformer-based networks, normalizing-flow networks, transformer networks. Siamese network, recurrent networks, or autoencoders, such as illustrated in the block diagram 100 in FIG. 1. An autoencoder 110 may learn a latent representation Z while reconstructing the image along with the following two functions: (1) an encoding function (performed by encoder 120) parameterized by θ that takes in image x as an input and outputs the values of latent variable z=(x); and (2) a decoding function (performed by decoder 130) parameterized by μ that takes in the values of latent variables and outputs an image, x′=D_{μ}(z), with the loss function as shown in FIG. 1 of I(x, x′).

Training of an autoencoder may determine θ and μ by solving the following optimization problem:

$${arg min}_{\begin{matrix}θ , & μ\end{matrix}} ‖ x - {D}_{μ} ( {E}_{θ} ( x ) ) ‖ \qquad ( 2 )$$

After training, one may use the learned encoding function E(x) to map an image (or a portion of image such as a patch) to its latent space (or embedding space) representation in Z. This representation of the image may be used for the image analysis. An example of an autoencoder architecture, which may include encoder 210 and decoder 220, is shown in the block diagram 200 in FIG. 2.

The latent space typically captures the high-level features in the image x and has dimension much smaller than that of x. It is often difficult to interpret the latent space because the mapping from x to z is nonlinear and no structure over this space is enforced during the training. One approach may be to compare the images in this space with reference images (or patches) using a distance function measuring similarity between the pair (e.g., |zₓ−z_{Reference}|). See A. Veillard, O. Morére, M. Grout and J. Gruffeille, “Fast 3D Seismic Interpretation with Unsupervised Deep Learning: Application to a Potash Network in the North Sea”, EAGE, 2018. There are two challenges for detecting DHIs with such an approach. First. DHIs are anomalous features in seismic images and autoencoders are designed to represent salient features, not the anomalous features. Anomalous features are typically treated as statistically not meaningful or significant for reconstructing images. Second, an autoencoder cannot guarantee to cluster image features in latent space and they may not be separable in the latent space.

The generative model may be based on a deep network, such as U-nd, as illustrated in the block diagram 300 of FIG. 3, in which an autoencoder (AE), variational autoencoder (VAE) or any other suitable network maps {x} to an output of stratigraphic or reservoir model {x^{˜}}. In cases of AE or VAE, the generative model G may be split into encoder or decoder portions, with the decoder portion being used directly to generate outputs after training is completed. The generative model G may be trained iteratively by solving an optimization problem which may be based on an objective functional involving discriminator D and a measure of reconstruction loss (e.g., an indication of the similarity of the generated data to the ground truth) and/or adversarial loss (e.g., loss related to discriminator being able to discern the difference between the generated data and ground truth).

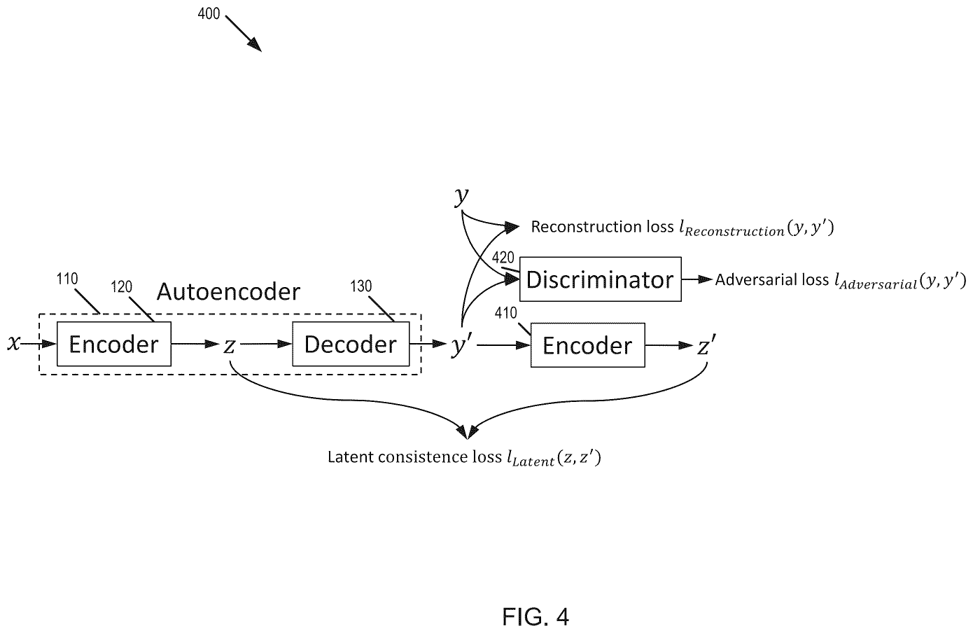

An unsupervised learning method may be used in order to construct B from A or in order to learn to reconstruct A and B from a pair of A and B. Statistically, a machine learning model learns, when trained, to construct seismic features which are common to the data set. One may infer if a feature is anomalous from its reconstruction quality. In particular, anomalous features may be poorly constructed. As discussed above, there are various ways to quantify whether the feature is poorly or adequately reconstructed. In particular, the quality of reconstructions may be inferred in a pixel-level image space, a learned representation space (e.g., latent space), or in a discriminator space. In one embodiment, the methodology may use, one, some, or each of the quality measurements in reconstructions of images to recognize or identify anomalous features, such as illustrated at 400 in FIG. 4. In particular, FIG. 4 illustrates different indications of loss. As one example, FIG. 4 illustrates as latent consistence loss, which indicates the loss or inconsistency in latent space comparing latent space z generated as an output from encoder 120 and latent space z′ generated as an output from encoder 410, which may be identical to encoder 120 and may be generated by inputting y′ (generated from decoder 130) into encoder 410. As another example, FIG. 4 illustrates reconstruction loss, which may determine an indication of loss through reconstruction by comparing y to y′. As still another, FIG. 4 illustrates adversarial loss, which may, using discriminator 420, loss between y to y′.

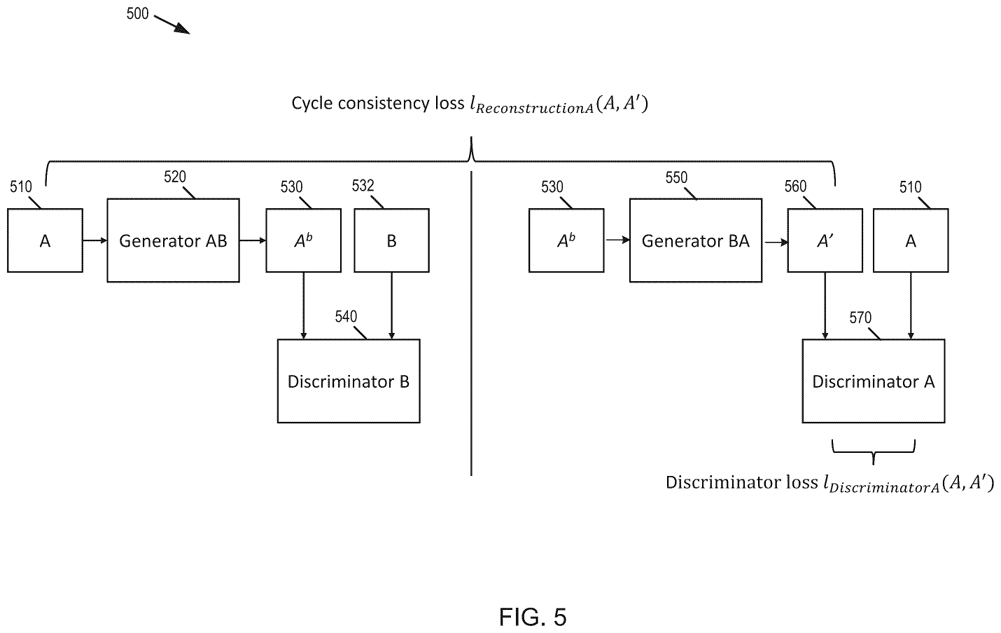

If A and B images are not paired, then the model may be trained in a cyclic fashion (e.g., cycleGANs). In this case, the model may learn the mapping between A and B by mapping A and “B space” and back to A and B to “A space” and back to B. The mapped images in “A space” and “B space” need not be compared to their pairs because image patches in A and B are not paired. Instead, the quality of images constructed in “A space” and “B space” may be evaluated with a discriminator which is also trained along the process to learn the distributions of realistic A and B images relative to the constructed ones (e.g., cycleGANs as illustrated in the block diagram 500 in FIG. 5 and further disclosed in US Patent Application Publication No. 2020/0183047 A1, incorporated by reference herein in its entirety).

Specifically, FIG. 5 illustrates the cycle consistency loss and the discriminator loss. The cycle consistency loss is determined by A (510) being input to generator AB (520), which outputs A^{b} (530), which along with B (532) is input to discriminator B (540). Further, A^{b} (530) is input to generator BA (550), which outputs A′ (560), which is input along with A (510) to discriminator (570) to generate the discriminator loss.

During the encoding, the spatial information of the input may often be reduced while the number of features may be increased. During the decoding, the features and the spatial information may be combined to produce the output. Additional constraints may be applied on the latent space to regularize the distribution of the latent space (e.g., standard normal distribution for latent space). Variational autoencoders and normalizing flow networks may impose such distributions on their latent spaces either explicitly or with a divergence penalty (e.g., Kulback-Liebler divergence).

The parameters of the model (e.g., weights and biases) may be optimized to pass the input image (e.g., near stack image) into the latent space, which is very often a reduced dimensional space compared to the input image space and reconstruct its pair (e.g., far stack images) to the best of its ability. It is expected that the dimensionality reduction will lead to an output image that is close, but not a perfect, reconstruction of the input image. As discussed above, in one or some embodiments, the loss of information or constraints over the latent space (e.g., standard normal distribution on the latent space) is purposefully exploited to highlight anomalies. The anomalous regions in the image may be statistically difficult to learn since the training samples containing these anomalies may be unbalanced and may be of insufficient size to effectively be modeled. Therefore, the model may fail to learn how to map (e.g., encode and decode) those areas in the image. By comparing the input and output in a norm (e.g., mean absolute error), the methodology may identify the most difficult areas to reconstruct in pixel space, and in turn identify the most anomalous. In one or some embodiments, various types of postprocessing may be performed. As one example, thresholding and/or denoising methods may be applied, thereby filtering the anomalies based on the neural network's reconstructive performance.

The quality and resolution of seismic images may often be depth and overburden dependent. The seismic responses of the rocks may also be depth dependent due to compaction. In addition, there may be dependences on the environment of deposition (EoD). Due to these dependencies, anomaly detection may be tailored in one or more ways based on these dependencies. As one example, anomaly detection may be evaluated in a particular context, which may be dependent on one or more factors, such as dependent on the depth. For instance, the shallow depth seismic responses are typically richer in quality, resolution, and amplitude dynamic ranges than their deeper counterparts even in similar EoD systems. Anomalous regions in one seismic section may not be anomalous for a different geologic context (e.g., depth or EoD). The anomalous features in the deeper seismic sections may also be expected to be more subtle than the shallower sections. For this reason, indicators of anomalous features may be evaluated in its local context. The geologic context may be provided by a stratigraphic zone EoD (e.g., channel versus delta), depth and/or geologic time (e.g., Jurassic versus Cretaceous). The model learning the mapping between A and B may be trained within a context to find anomalous features within that region. For instance, a supervised machine learning model (e.g., U-net such as illustrated in FIG. 3) may be trained to segment stratigraphic zones. Then, the anomaly detection may be performed within each zone independently. The zones may also be defined by an expert who understands the geological context.

Because of the depth, EoD and overburden dependencies of seismic responses, additional information including geophysical models (e.g., P and S velocities and density models), depth information, EoD classes and stratigraphic zone classes may be provided to the training process as inputs (e.g., via input channels) to the model. In particular, various additional channels of information, such as geophysical models (e.g., P and S velocity models, density) may allow the model to condition in geophysically meaningful fashion the constructions of partial stacks with the information via the additional channels so to better determine anomalous features of interest. The model may then learn the mapping from (A, C) to B where C corresponds to the set of additional information. C may reside in the pixel space as similar to the seismic images. This additional information may inform the model about where the patch is coming from (e.g., any one, any combination, or all of depth, EoD, stratigraphic zone, geological age, geophysical properties or etc.), so that the model may construct B (e.g., far stack image) within a geophysical and geological expectations.

In some instances, some of the anomalous regions may be known and may purposefully be avoided in the training by minimizing samples from those regions containing anomalies. During training, patches may be extracted from seismic volume for the model to reconstruct as described above. By withholding example patches that have anomalous features of interests within them, the methodology purposefully inhibits the model's ability to learn the features necessary to reconstruct features (e.g., salient features) within the image. Thus, the model may be trained using data in order to reconstruct certain features that, while potentially being considered an anomaly, are not considered anomalies of interest. In this way, the model may reconstruct the image with these certain features accurately, so that these features are not later identified as anomalies. Conversely, data may be explicitly excluded (or minimized) that are directed to certain features of interest (e.g., pinch-out structures or bright spots). Thus, the model may fail to reconstruct these certain features of interest, and in turn be identified as anomalies. In particular, even when training samples still contain anomalies of interest, by providing an overwhelming large amount of non-anomalous (e.g., background) data supplied to the model during training biases the model to learn background more effectively and ignore the rare instances of anomalies (or foreground) within the training dataset.

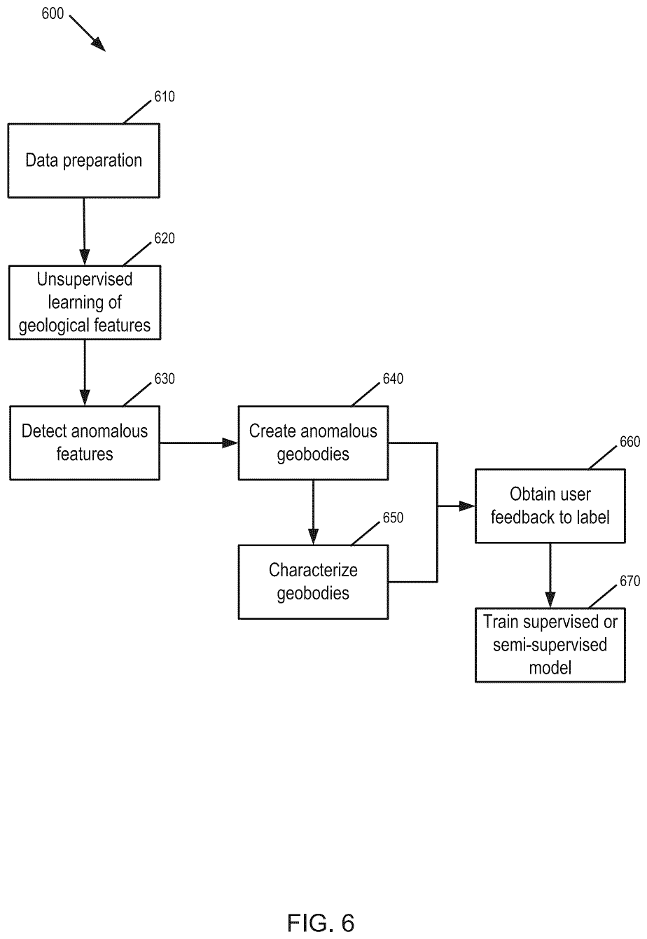

FIG. 6 illustrates an example workflow 600 for detecting anomalous features. At 610, data preparation is performed. At 620, unsupervised learning of geological features is performed. In one embodiment, the unsupervised learning comprises learning the mapping between A and B or (A, B) and (B, A) using an unsupervised algorithm. For example, after training, the model is configured for at least one of: the near stack image is input to the model and the far-stack image is output from the model; the near stack image and the mid-stack image are input to the model and the far-stack image is output from the model; the near stack image and far stack image are input to the model and the mid stack image is output from the model; or the near stack image, mid stack image and far stack image are input to the model and the near stack image, mid stack image and far stack image are also output from the model.

At 630, anomalous features are detected. As discussed above, various ways are contemplated to detect anomalous features. As one example, the anomalous features are detected based on the reconstruction quality of A or B. Further, various anomalous features to detect am contemplated. For example, anomalous features may have forms of structural irregularities (e.g., channel systems) or amplitude irregularities (e.g., bright spots) or a combination of both within a seismic volume.

In one embodiment, data preparation comprises gathering partial stack image patches paired or unpaired and augmentation of patches. As discussed above, not all anomalous features may be of interest for subsurface exploration. In order not to detect the uninteresting anomalous features (see 630), those features may be sampled more often than other features of interest. Alternatively, or in addition, augmentation strategies may be used to enforce model invariances on those uninteresting anomalous features. For instance, dipping structures may be detected as anomalous features if the common structural patterns in training patches are horizontal (with zero dipping angle). Horizontal features (e.g., layers) may be rotated over a range of dipping angles to enforce that machine learning model learns rotational invariance over the dip angles.

At 640, anomalous geobodies are created. Specifically, the detection of anomalous features from 630 may enable the delineation of geobodies using, for instance, a seed detection algorithm [Oz Yilmaz, Seismic Data Analysis, 2001]. At 650, the geobodies may be characterized. For example, these geobodies may later be classified with respect to their AVO types (e.g., I, II, Ip, III, IV) and characterized with additional seismic analysis methods such as petrophysical inversions to estimate porosity and volume of clay distributions within the geobodies. In this way, the detected anomalous features may be converted into geobody objects that are characterized by a geophysical inversion method such as AVO inversion.

At 660, user feedback may be obtained to label. For example, geobodies (e.g., subsurface objects with attributes) generated using anomalous features may be used to obtain the user feedback to discriminate whether they are the geobodies of interest for hydrocarbon exploration or not. Based on this feedback, at 670, a supervised or semi-supervised algorithm may train a model to learn segmenting those interesting geobodies.

The following is one example for illustration purposes only. For a given stratigraphic context, a set of near- and far-stack seismic images are gathered (see, e.g., the near and far-stack seismic images are obtained from New Zealand Petroleum and Minerals (NZPM) and they are released to public at http://data.nzpam.govt.nz/GOLD/system/mainframe.asp). To identify the anomalous features within this stratigraphic context, a model architected in FIG. 2 may be trained with the loss functions as shown in FIG. 4 using the given near stack seismic images as the input and far stack seismic images as the target output. It is noted that there is no need to separate the training and inference data for this application. In this way, the model is driven to learn the background patterns specific to the region of interest. The predictions show that the model does not over fit to images and the anomalous regions are predicted using an absolute-error-norm-based reconstructive loss between the reconstructed far-stack images and the given far stack images.

The seismic images are normalized between [−1, 1] and a hyperbolic-tangent (tanh) layer is used with the decoder to strictly enforce its outputs between [−1, 1]. The normalization eases the learning for the model since there original numerical range of the seismic is quite large.

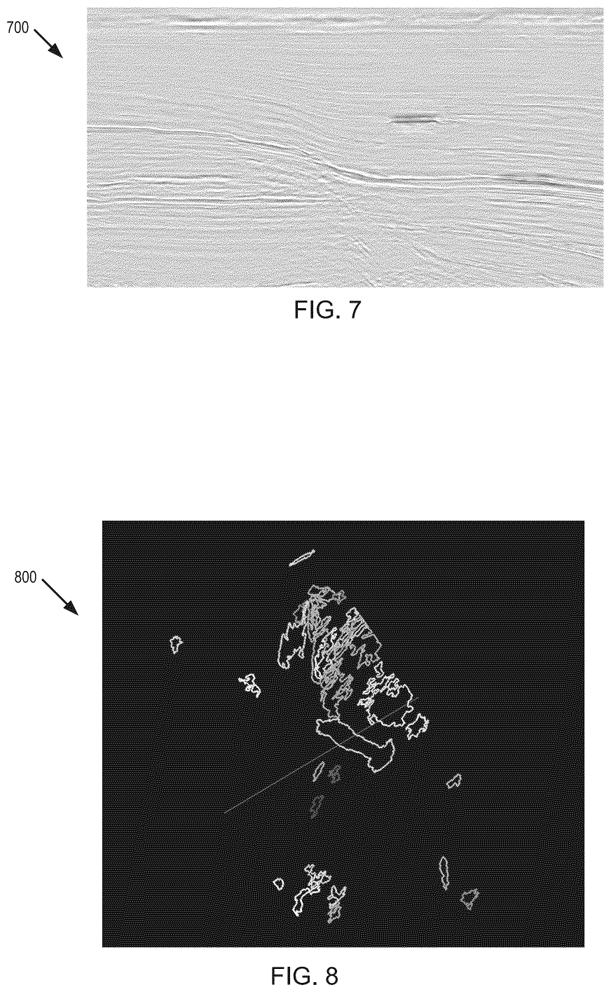

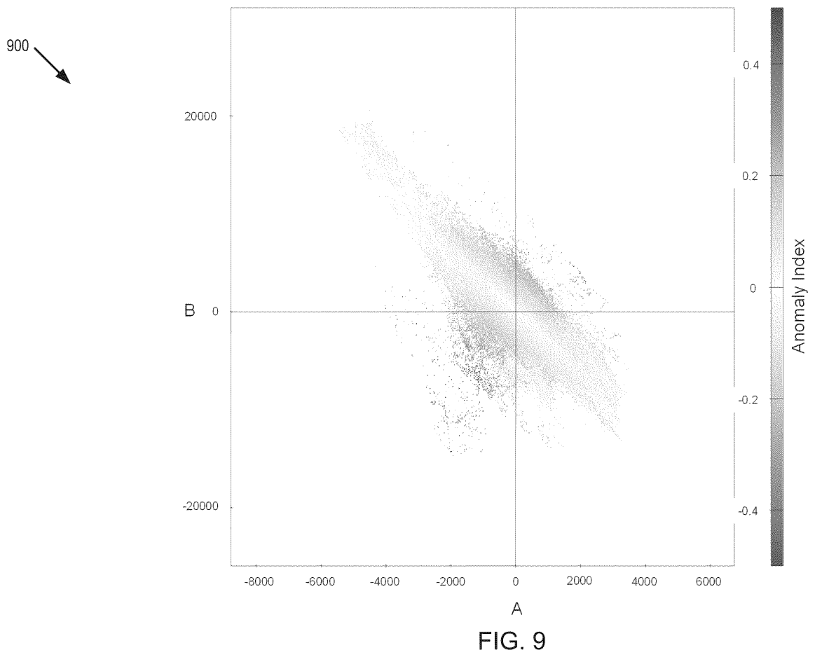

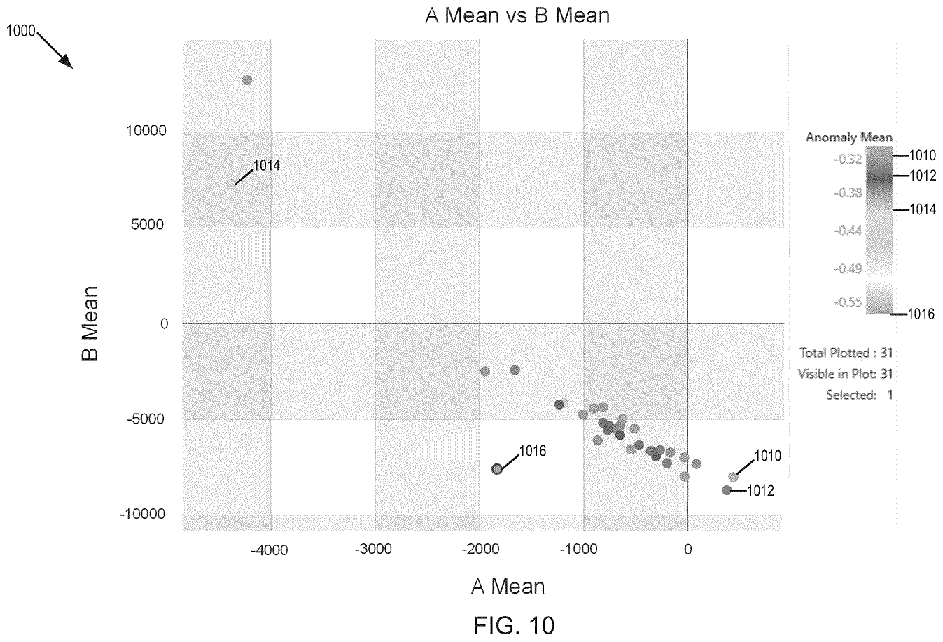

Following to the training, the prediction is performed on the near-stack volume patch-by-patch to generate the far-stack volume. The true far-stack volume is normalized for the analysis to align with the distribution learned by the model. The generated far-stack is compared to the normalized true far-stack using an absolute distance norm |d_{Generated}−d_{True}|. The regions that are most accurately predicted (e.g., the background) are diminished, and the regions which are less accurately predicted are brought to the foreground. Using thresholding, the background may be eliminated and the anomalous (e.g., foreground) features may be highlighted, such as shown in the illustration 700 in FIG. 7. A seed detection algorithm may be leveraged to extract 3D bodies from this error volume, such as shown in the illustration 800 in FIG. 8. The distributions of anomaly index based on distance |d_{Generated}−d_{True}| are displayed at 900 in FIG. 9 in AVO space for each pixel in FIG. 7. The extracted geobodies in FIG. 8 are characterized in the AVO space as depicted in the graph 1000 FIG. 10, with 1010, 1012, 1014, 1016 as visible plot entries and with 1016 comprising the selected plot entry.

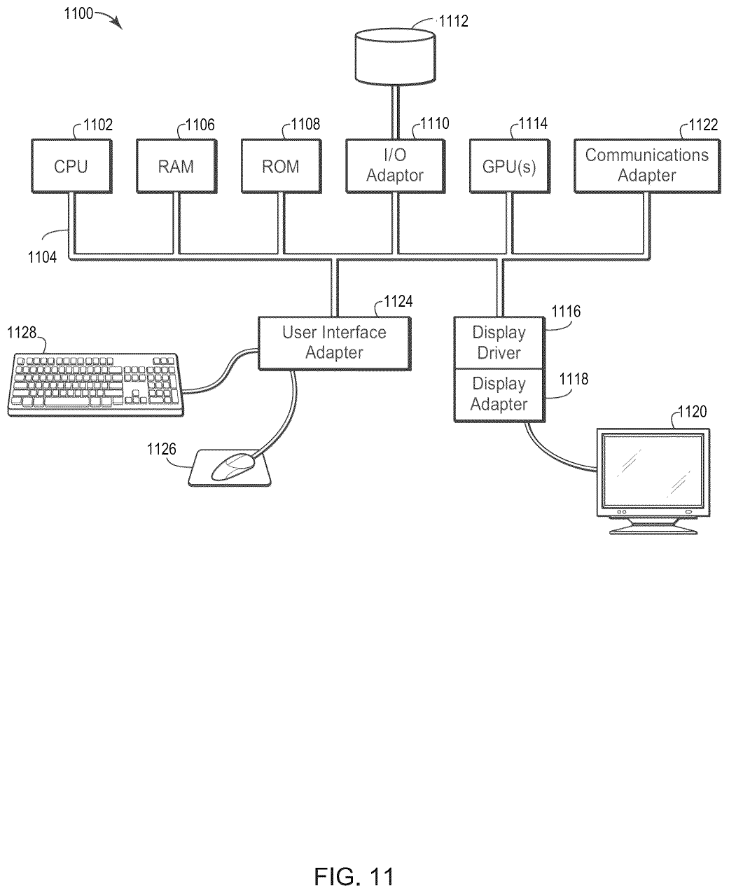

In all practical applications, the present technological advancement must be used in conjunction with a computer, programmed in accordance with the disclosures herein. For example, FIG. 11 is a diagram of an exemplary computer system 1100 that may be utilized to implement methods described herein. A central processing unit (CPU) 1102 is coupled to system bus 1104. The CPU 1102 may be any general-purpose CPU, although other types of architectures of CPU 1102 (or other components of exemplary computer system 1100) may be used as long as CPU 1102 (and other components of computer system 1100) supports the operations as described herein. Those of ordinary skill in the art will appreciate that, while only a single CPU 1102 is shown in FIG. 11, additional CPUs may be present. Moreover, the computer system 1100 may comprise a networked, multi-processor computer system that may include a hybrid parallel CPU/GPU system. The CPU 1102 may execute the various logical instructions according to various teachings disclosed herein. For example, the CPU 1102 may execute machine-level instructions for performing processing according to the operational flow described.

The computer system 1100 may also include computer components such as non-transitory, computer-readable media. Examples of computer-readable media include computer-readable non-transitory storage media, such as a random-access memory (RAM) 1106, which may be SRAM, DRAM, SDRAM, or the like. The computer system 1100 may also include additional non-transitory, computer-readable storage media such as a read-only memory (ROM) 1108, which may be PROM, EPROM, EEPROM, or the like. RAM 1106 and ROM 1108 hold user and system data and programs, as is known in the art. The computer system 1100 may also include an input/output (I/O) adapter 1110, a graphics processing unit (GPU) 1114, a communications adapter 1122, a user interface adapter 1124, a display driver 1116, and a display adapter 1118.

The I/O adapter 1110 may connect additional non-transitory, computer-readable media such as storage device(s) 1112, including, for example, a hard drive, a compact disc (CD) drive, a floppy disk drive, a tape drive, and the like to computer system 1100. The storage device(s) may be used when RAM 1106 is insufficient for the memory requirements associated with storing data for operations of the present techniques. The data storage of the computer system 1100 may be used for storing information and/or other data used or generated as disclosed herein. For example, storage device(s) 1112 may be used to store configuration information or additional plug-ins in accordance with the present techniques. Further, user interface adapter 1124 couples user input devices, such as a keyboard 1128, a pointing device 1126 and/or output devices to the computer system 1100. The display adapter 1118 is driven by the CPU 1102 to control the display on a display device 1120 to, for example, present information to the user such as subsurface images generated according to methods described herein.

The architecture of computer system 1100 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 1100 may include various plug-ins and library files. Input data may additionally include configuration information.

Preferably, the computer is a high-performance computer (HPC), known to those skilled in the art. Such high-performance computers typically involve clusters of nodes, each node having multiple CPU's and computer memory that allow parallel computation. The models may be visualized and edited using any interactive visualization programs and associated hardware, such as monitors and projectors. The architecture of system may vary and may be composed of any number of suitable hardware structures capable of executing logical operations and displaying the output according to the present technological advancement. Those of ordinary skill in the art are aware of suitable supercomputers available from Cray or IBM or other cloud computing based vendors such as Microsoft. Amazon.

The above-described techniques, and/or systems implementing such techniques, can further include hydrocarbon management based at least in part upon the above techniques, including using the AI model in one or more aspects of hydrocarbon management. For instance, methods according to various embodiments may include managing hydrocarbons based at least in part upon the one or more generated AI models and data representations constructed according to the above-described methods. In particular, such methods may include performing various welds in the context of drilling a well, and/or causing a well to be drilled, based at least in part upon the one or more generated geological models and data representations discussed herein (e.g., such that the well is located based at least in part upon a location determined from the models and/or data representations, which location may optionally be informed by other inputs, data, and/or analyses, as well) and further prospecting for and/or producing hydrocarbons using the well.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

The following example embodiments of the invention are also disclosed:

Embodiment 1: A computer-implemented method for detecting anomalous features from seismic images comprising:
accessing input seismic stack images;
performing unsupervised machine learning, using at least a part of the seismic stack images, to generate a model that is configured to reconstruct the seismic stack images;
using the model in order to generate reconstructed seismic stack images;
assessing reconstructive errors based on the reconstructed seismic stack images with the input seismic stack images;
detecting the anomalous features based on the assessment of the reconstructive errors; and
using the detected anomalous features for hydrocarbon management.

Embodiment 2: The method of embodiment 1: wherein the unsupervised machine learning is performed so that the model is trained not to reconstruct the anomalous features competently.

Embodiment 3: The method of embodiments 1 or 2:
wherein the anomalous features comprise anomalous features of interest and anomalous features not of interest; and
wherein the training to learn reconstruction is such that the model is not configured to sufficiently reconstruct the anomalous features of interest and is configured to sufficiently reconstruct the anomalous features not of interest.

Embodiment 4: The method of any of embodiments 1-3:
wherein the training to learn reconstruction is such that the model is not configured to sufficiently reconstruct the anomalous features of interest and is configured to sufficiently reconstruct the anomalous features not of interest comprises:
performing data preparation in order to generate additional training data associated with the anomalous features not of interest or reduce training data associated with the anomalous features of interest.

Embodiment 5: The method of any of embodiments 14:
wherein the model reconstructs the anomalous features of interest with variances thereby being unable to sufficiently reconstruct the anomalous features of interest;
wherein the model reconstructs the anomalous features not of interest with invariance thereby being able to sufficiently reconstruct the anomalous features not of interest; and
wherein the data preparation comprises sampling or data augmentation in order to generate the additional training data in order for the model to learn the invariance.

Embodiment 6: The method of any of embodiments 1-5:
wherein the anomalous features not of interest comprise background;
wherein the data preparation comprises segmenting images into at least one zone of interest; and
wherein training to learn reconstruction is for the at least one zone of interest in order for the trained model to sufficiently reconstruct the background in the at least one zone of interest.

Embodiment 7: The method of any of embodiments 1-6:
wherein the anomalous features of interest comprise amplitude;
wherein the anomalous features not of interest comprise structural anomalies; and
wherein the data augmentation comprises rotating seismic images in order to train the model to sufficiently reconstruct the structural anomalies.

Embodiment 8: The method of any of embodiments 1-7:
wherein assessing the reconstructive errors comprises at least one of: (1) reconstruction loss at a pixel level; (2) reconstruction at a latent space; or (3) generative adversarial network (GAN) rating of an anomalous feature.

Embodiment 9: The method of any of embodiments 1-8:
wherein detecting the anomalous features based on the assessment of the reconstructive errors comprises weighting of (1), (2) and (3).

Embodiment 10: The method of any of embodiments 1-9:
further comprising performing supervised machine learning to generate a second model; and
wherein detecting the anomalous features is based on both the assessment of the reconstruction errors and based on the second model.

Embodiment 11: The method of any of embodiments 1-10:
further comprising randomly sampling patches from the input seismic stack images; and
wherein training the machine learning model uses the patches from the input seismic stack images.

Embodiment 12: The method of any of embodiments 1-11:
further comprising converting the detected anomalous features into geobody objects that are characterized by a geophysical inversion method.

Embodiment 13: The method of any of embodiments 1-12:
further comprising:
using the characterized geobodies to compile user feedback regarding whether the detected anomalous features are anomalous or not; and
using the user feedback to retrain the model.

Embodiment 14: The method of any of embodiments 1-13:
wherein the input stack images am pre- or partially-stack images.

Embodiment 15: The method of any of embodiments 1-14:
wherein the pre- or partially-stack images comprises near stack image, mid stack image, and far stack image;
wherein the model is configured for at least one of:
   the near stack image is input to the model and the far stack image is output from the model;
   the near stack image and the mid stack image am input to the model and the far stack image is output from the model;
   the near stack image and far stack image am input to the model and the mid stack image is output from the model; or
   the near stack image, mid stack image and far stack image am input to the model and the near stack image, mid stack image and far stack image am also output from the model.

Embodiment 16: The method of any of embodiments 1-15:
wherein one or more pre-stack input images am used to construct other pre-stack images; or
wherein all pre-stack images am inputs to the model and all pre-stack images am outputs from the model.

Embodiment 17: The method of any of embodiments 1-16:
wherein the unsupervised machine learning is constrained to a geologic context where anomalous features am defined.

Embodiment 18: The method of any of embodiments 1-17:
wherein the geologic context is based on at least one of geologic age, zone, environment of deposition, depth or facies.

Embodiment 19: The method of any of embodiments 1-18:
wherein inputs to the model include geophysical inversion results, depth, geologic zone, geologic age, environment of deposition, and the input seismic stack images.

Embodiment 20: The method of any of embodiments 1-19:
wherein the model is based on autoencoders, autoencoders with skip layers, generative adversarial networks, recurrent networks, transformer networks, or normalizing flow networks.

Embodiment 21: The method of any of embodiments 1-20:
wherein a cycleGAN model is used to learn mapping across the input seismic stack images when the input seismic stack images am unpaired.

Embodiment 22: A system comprising:
a processor, and
a non-transitory machine-readable medium comprising instructions that, when executed by the processor, cause a computing system to perform a method according to any of embodiments 1-21.

Embodiment 23: A non-transitory machine-readable medium comprising instructions that, when executed by a processor, cause a computing system to perform a method according to any of embodiments 1-21.

### REFERENCES

The following references are hereby incorporated by reference herein in their entirety, to the extent they are consistent with the disclosure of the present invention:
LeCun, Y., Bengio, Y., & Hinton, G., “Deep Learning.”, Nature 521, 436-444 (2015).
Simonians, K., & Zissennan, A., “Very Deep Convolutional Networks for Large-Scale Image Recognition.”, arXiv technical report (2014).
Jonathan Long, Evan Shelhamer, and Trevor Darrell., “Fully Convolutional Networks for Semantic Segmentation”, CVPR (2015).
Olaf Ronneberger, Philipp Fischer, Thomas Brox, “U-Net: Convolutional Networks for Biomedical Image Segmentation”, Medical Image Computing and Computer-Assisted Intervention (MICCAI), Springer, LNCS, Vol. 9351: 234-241 (2015).
Zhang, C., Frogner, C., & Poggio, T., “Automated Geophysical Feature Detection with Deep Learning”, GPU Technology Conference (2016).
Jiang, Y., Wulff, B., “Detecting prospective structures in volumetric geo-seismic data using deep convolutional neural networks”, Poster presented on Nov. 15, 2016 at the annual foundation council meeting of the Bonn-Aachen International Center for Information Technology (b-it) (2016).
J. Mun, W. D. Jang, D. J. Sung and C. S. Kim, “Comparison of objective functions in CNN-based prostate magnetic resonance image segmentation,” 2017 IEEE International Conference on Image Processing (ICIP). Beijing, pp. 3859-3863 2017).
K. H. Zou, S. K. Warfield, A. Bharatha, C. M. C. Tempany, M. R. Kaus, S. J. Haker, W. M. Wells III, F. A. Jolesz, R. Kikinis, “Statistical validation of image segmentation quality based on a spatial overlap index”, Acad. Radiol., 11 (2), pp. 178-189 (2004).
I. J. Goodfellow, J. Pouget-Abadie, M. Mirza, B. Xu, D. Warde-Farley, S. Ozair, A. C. Courville, and Y. Bengio, “Generative adversarial nets”, In Proceedings of NIPS, pages 2672-2680 (2014).
A. Veillard, O. Mortre, M. Grout and J. Gruffeille, “Fast 3D Seismic Interpretation with Unsupervised Deep Learning: Application to a Potash Network in the North Sea”, EAGE, (2018).
Jun-Yan Zhu, Taesung Park, Phillip Isola, and Alexei A. Efros, “Unpaired Image-to-Image Translation using Cycle-Consistent Adversarial Networks”, in IEEE International Conference on Computer Vision (ICCV) (2017).
Xun Huang, Ming-Yu Liu, Serge Belongie, Jan Kautz, “Multimodal Unsupervised Image-to-Image Translation”, ECCV (2018).
S Akcay, A Atapour-Abarghouei, T P Breckon, “Ganomaly: Semi-supervised anomaly detection via adversarial training”, Asian Conference on Computer Vision, 622-637 (2018).

What is claimed is:

1. A computer-implemented method for detecting anomalous features from seismic images, the method comprising:
accessing input seismic stack images;
performing unsupervised machine learning, using at least a part of the seismic stack images, to generate a model that is configured to reconstruct the seismic stack images;
using the model in order to generate reconstructed seismic stack images;
assessing reconstructive errors based on the reconstructed seismic stack images with the input seismic stack images;
detecting the anomalous features based on the assessment of the reconstructive errors; and
using the detected anomalous features for hydrocarbon management.

2. The method of claim 1, wherein the unsupervised machine learning is performed so that the model is trained not to reconstruct the anomalous features competently.

3. The method of claim 2, wherein the anomalous features comprise anomalous features of interest and anomalous features not of interest; and
wherein the training to learn reconstruction is such that the model is not configured to sufficiently reconstruct the anomalous features of interest and is configured to sufficiently reconstruct the anomalous features not of interest.

4. The method of claim 3, wherein the training to learn reconstruction is such that the model is not configured to sufficiently reconstruct the anomalous features of interest and is configured to sufficiently reconstruct the anomalous features not of interest comprises:
performing data preparation in order to generate additional training data associated with the anomalous features not of interest or reduce training data associated with the anomalous features of interest.

5. The method of claim 4, wherein the model reconstructs the anomalous features of interest with variances thereby being unable to sufficiently reconstruct the anomalous features of interest;
wherein the model reconstructs the anomalous features not of interest with invariance thereby being able to sufficiently reconstruct the anomalous features not of interest; and
wherein the data preparation comprises sampling or data augmentation in order to generate the additional training data in order for the model to learn the invariance.

6. The method of claim 5, wherein the anomalous features not of interest comprise background;
wherein the data preparation comprises segmenting images into at least one zone of interest; and
wherein training to learn reconstruction is for the at least one zone of interest in order for the trained model to sufficiently reconstruct the background in the at least one zone of interest.

7. The method of claim 5, wherein the anomalous features of interest comprise amplitude;
wherein the anomalous features not of interest comprise structural anomalies; and
wherein the data augmentation comprises rotating seismic images in order to train the model to sufficiently reconstruct the structural anomalies.

8. The method of claim 1, wherein assessing the reconstructive errors comprises at least one of: (1) reconstruction loss at a pixel level; (2) reconstruction at a latent space; or (3) generative adversarial network (GAN) rating of an anomalous feature.

9. The method of claim 8, wherein detecting the anomalous features based on the assessment of the reconstructive errors comprises weighting of (1), (2) and (3).

10. The method of claim 1, further comprising performing supervised machine learning to generate a second model; and
wherein detecting the anomalous features is based on both the assessment of the reconstruction errors and based on the second model.

11. The method of claim 1, further comprising randomly sampling patches from the input seismic stack images; and
wherein training the machine learning model uses the patches from the input seismic stack images.

12. The method of claim 1, further comprising converting the detected anomalous features into geobody objects that are characterized by a geophysical inversion method.

13. The method of claim 12, further comprising:
using the characterized geobodies to compile user feedback regarding whether the detected anomalous features are anomalous or not; and
using the user feedback to retrain the model.

14. The method of claim 1, wherein the input stack images are pre- or partially-stack images.

15. The method of claim 14, wherein the pre- or partially-stack images comprises near stack image, mid stack image, and far stack image;
wherein the model is configured for at least one of:
the near stack image is input to the model and the far stack image is output from the model;
the near stack image and the mid stack image are input to the model and the far stack image is output from the model;
the near stack image and far stack image are input to the model and the mid stack image is output from the model; or
the near stack image, mid stack image and far stack image are input to the model and the near stack image, mid stack image and far stack image are also output from the model.

16. The method of claim 14, wherein one or more pre-stack input images are used to construct other pre-stack images; or
wherein all pre-stack images are inputs to the model and all pre-stack images are outputs from the model.

17. The method of claim 1, wherein the unsupervised machine learning is constrained to a geologic context where anomalous features are defined.

18. The method of claim 17, wherein the geologic context is based on at least one of geologic age, zone, environment of deposition, depth or facies.

19. The method of claim 1, wherein inputs to the model include geophysical inversion results, depth, geologic zone, geologic age, environment of deposition, and the input seismic stack images.

20. The method of claim 1, wherein the model is based on autoencoders, autoencoders with skip layers, generative adversarial networks, recurrent networks, transformer networks, or normalizing flow networks.

21. The method of claim 1, wherein a cycleGAN model is used to learn mapping across the input seismic stack images when the input seismic stack images are unpaired.
